(19) United States
(12) Patent Application Publication
(10) Pub. No.: US 2012/0020622 A1
(43) Pub. Date: Jan. 26, 2012

(54) PLANAR NANOPHOTONIC WAVEGUIDE COMPRISING A STRUCTURE FOR OPTICAL COUPLING WITH AN OPTICAL FIBRE

(76) Inventors: Christophe Kopp, Fontanil-Cornillon (FR); Stéphane Bernabe, Moirans (FR)

(21) Appl. No.: 13/189,198

(22) Filed: Jul. 22, 2011

(30) Foreign Application Priority Data
Jul. 23, 2010 (FR) 1056033

(51) Int. Cl. G02B 6/34

(52) U.S. Cl. 385/36

(57) ABSTRACT

A single-mode planar nanophotonic waveguide includes an optical core, a cladding coating the optical core, and a structure for the optical coupling of the core of the waveguide with the core of a single-mode optical fibre. The coupling structure includes an adaptation element including a gradual broadening of the core of the waveguide ending in a broadened region of dimension adapted to the core of the optical fibre; and a light transmission element, optically connected to the broadened region, and defining a plane coupling surface by which light is transmitted to the optical fibre, the optical coupling ratio through the surface when the surface is in contact with the air being maximum for a predetermined coupling angle (θ) of the light relative to the coupling surface.

### CROSS-REFERENCE TO RELATED APPLICATIONS

The present application claims priority of pending French Patent Application No. 1056033, filed on Jul. 23, 2010, the content of which is incorporated herein by reference.

### FIELD OF THE INVENTION

The invention relates to the field of optoelectronic components, and particularly nanophotonic circuits defined by waveguides of less than one micrometre in size.

More specifically, the invention relates to the coupling of such nanophotonic circuits with single-mode optical fibres, which have a core much more than one micrometre in size.

### BACKGROUND OF THE INVENTION

Planar, i.e. rectangular-geometry, optical waveguide technologies enable complex optical beam management functions, such as multiplexing, de-multiplexing, modulation and spectral routing for example, to be integrated very compactly into a single chip.

Not only can planar optical waveguides be used to implement necessary functions, both for optical links over very short distances of about one millimetre, such as optical links internal to a chip for example, and over very long distances of several kilometres, such as links on a metropolitan communications network for example, but said waveguides also deliver very high data flow rates thereby constituting technologies of choice in response to the constant increase in demand for throughput.

Furthermore, the integration of a growing number of optical functions onto one and the same chip surface requires an extreme miniaturisation of the optical circuits, thereby leading to a growing miniaturisation of the cross-section of the planar optical guides, down to submicronic dimensions, hence the reference to “nanophotonic” guides. It is therefore not unusual to have optical guide sections of 0.5 micrometres by 0.2 micrometres for rectangular-section waveguide cores.

In fact, for medium- and long-distance applications, i.e. applications requiring data transmission over distances from a few metres to a plurality of kilometres, the only appropriate transmission medium is optical fibre, which has a section with a diameter of more than ten micrometres, or even more than a hundred micrometres. Consequently, it is necessary to provide adaptation or coupling systems, between the planar nanophotonic waveguides and the optical fibres, in order to compensate for this continually growing mismatch of dimensions, and to compensate for a difference in behaviour between waveguides and optical fibres in respect of light polarisation.

Usually, the adaptation between a single-mode planar nanophotonic waveguide and a single-mode optical fibre is implemented by a surface coupling element that includes a “taper”, formed in the waveguide which adapts the dimensions of the guide to that of the fibre, and an optical element which makes the interface between the “taper” and the optical fibre, to advantage a diffraction grating formed of periodic slits.

FIGS. 1 and 2 are a sectional view and a detailed view from above respectively of such an optical coupling structure 10 from the prior art, implemented in a single-mode planar nanophotonic waveguide 12, and intended for optical coupling with a single-mode optical fibre 14. FIGS. 3A and 3B are for their part perspective views of two alternative embodiments of a planar nanophotonic waveguide 12 from the prior art.

A planar waveguide 12 comprises, for the transmission of light in a nanophotonic circuit, a guide core 16 of submicronic dimension, made for example of silicon, indium phosphide, silicon nitride, or silica doped with photophore, boron or germanium. The core 16 is inserted between plane lower 18 and upper 20 cladding, made for example of silica, silicon nitride, silica doped with photophore, boron or germanium, silicon oxide, or constituted by air. This stack is itself formed on a substrate 22, made of silicon for example.

The core 16 of the planar waveguide 12 may assume different geometries, and be for example of T-shaped section, as shown in FIG. 3A (a waveguide of the “ridge” type), or of rectangular section, as shown in FIG. 3B (waveguide of the “ribbon” type).

Furthermore, the single-mode optical fibre 14, cylindrical in shape, includes a cylindrical fibre core 24, coated with cylindrical cladding 24. The diameter of the core 24 of the fibre 14 is commonly less than 10 micrometres for single-mode fibres and the outer diameter of the cladding 24 is commonly about a hundred micrometres.

The structure and the operation of the planar waveguide 12 and the single-mode optical fibre 14 that have just been described are well known from the prior art and will not therefore be described in further detail for reasons of conciseness.

The waveguide 12 further comprises furthermore an optical coupling structure which allows the light to be transmitted from the core 16 of the waveguide 12, with the submicronic dimensions, towards the core 24 of the optical fibre 14, of diameter commonly of between 8 and 10 micrometres, and vice versa, which comprises:
a region 28, commonly known as a “taper”, which consists of a gradual broadening of the core 16 of the planar waveguide 12, the region 28 ending in a broadened plane region 30 of dimensions compatible with the diameter of the core 24 of the fibre 14; and
a periodic grating of parallel slits 32, perpendicular to the main direction of the planar waveguide 12, engraved on the upper face of the broadened region 30, of length L and of width I greater than or equal to the diameter of the core 24 of the fibre 14.

The grating 32 thus forms a diffraction grating that allows the light contained in the region 30 to escape, via the upper cladding 20, towards the optical fibre 14, and the light coming from the optical fibre 14 to enter into the region 30, via the upper cladding 20. The features of the grating 32 are determined for a wavelength for transmission between the guide 12 and the fibre 14.

The light is therefore exchanged between the waveguide 12 and the optical fibre 14 through a plane surface 34 of the upper cladding 20, hereinafter referred to as the “coupling surface”.

A major problem with this type of optical coupling structure 10 is the positioning in space of the optical fibre 14 in respect of the coupling surface 34, or equivalently in respect of the slit-grating 32.

Indeed, the coupling ratio between the guide 12 and the fibre 14 (relationship between the amplitude of the light at the surface 34 in the direction of the optical fibre 14 and the amplitude of the light at the surface 34 in the direction of the waveguide 12), is optimum when the direction of propagation of the light forms an angle θ relative to the normal direction at the coupling surface 34. This optimum angle is commonly known as the “coupling angle”.

The coupling angle depends on the nature of the materials and on the dimensions of the adaptation structure 10, on the refractive index of the medium with which the coupling surface 34 is in contact, and on the wavelength of the transmitted light, and is usually between 0° and 30°. If the direction of the light deviates from the coupling angle θ, a very substantial deterioration is observed in the coupling ratio, such a loss being able to render the coupling ineffective.

It is therefore appropriate for the output section 36 of the optical fibre 14 to be as perpendicular as possible to the preferred direction of propagation of the light defined by the coupling angle θ. The angular positioning of the fibre 14 is thus optimum when its section 36 itself forms the coupling angle θ with the surface 34.

FIG. 4 shows this loss effect for a coupling set to the 1550 nanometre wavelength, an upper cladding 20 of silica with a refractive index n=1.44 and a thickness of 700 nanometres, a ribbon type guide core 12 of silicon with a refractive index equal to 3.47 and a thickness of 220 nanometres extending, via the “taper” 28, by a broadened region 30 wherein a grating 32 is engraved 10 micrometres in width and in length, the periodicity and the depth of the slits being 630 nanometres and 70 nanometres respectively, and a lower cladding 18 of silica with a refractive index equal to 1.44 and a thickness of 2 micrometres. When the coupling surface 34 is in contact with the air, with a refractive index equal to 1, the coupling angle is then equal to 10°.

FIG. 4 is a decibel curve of the coupling ratio as a function of the angular deviation in the output section 36 relative to the coupling angle θ. It can thus be seen that an angular deviation of 2.7° relative to the coupling angle θ brings about a loss of 20% of the coupling ratio. This reaches 40% when the angular deviation is equal to 4°.

Not only therefore does the optical fibre 14 need to be positioned angularly with precision, but it is also necessary to position the core 24 of the fibre 14 and the coupling surface 34 on the same optical path. It will be noted in this respect that even a small misalignment of the core 24 and of the surface 34 also leads to significant transmission losses. Thus for example, an offset of 2 μm reduces the transmission by 15%.

In fact, the relative positioning of micrometric elements is very tricky and requires a complicated procedure. This procedure comprises, during the positioning itself, measuring the light transmission between the fibre 14 and the waveguide 12, and considering the positioning as correctly implemented when transmission is maximum.

However, the optical fibre 14 also needs to be held in place once the positioning is correctly implemented. In fact, the only effective way hitherto to hold the fibre 14 in place is to secure it to the upper cladding 20 by means of an adhesive.

As stated above, the coupling angle θ depends on the refractive index of the medium with which the coupling surface 34 is in contact, and therefore on the refractive index of the adhesive used. Ideally therefore, the positioning should be implemented in the adhesive in order to optimise the coupling angle. In fact, positioning directly in the adhesive requires the provision of extra adhesive so that adhesive can be retained between the fibre and the grating despite movements of the fibre when its positioning is being optimised. But above all, the viscosity of the adhesive hinders the movements of the optical fibre and prevents any accurate positioning.

Usually, positioning is therefore carried out in the air, i.e. a positioning which is optimised for the coupling angle θ in the air, and the adhesive is then added in order to secure the fibre 14. The result therefore is an alignment which is not achieved for the true coupling angle, namely the one that is a function of the refractive index of the adhesive, and consequently the result is a reduced coupling ratio once the adhesive is added.

FIG. 5 shows the difference between the coupling angle in the air and the coupling angle in the adhesive with a refractive index equal to 1.45 for different wavelengths around the 1550 nanometre wavelength. As can be seen, a difference of several degrees is observed. For example, a coupling angle difference of 4° is seen between air and adhesive. With reference to FIG. 5, this is equivalent to a trimming of the coupling ratio of about 40%.

Despite this significant observed loss, the solution comprising positioning in the air followed by adhesion is more often than not preferred because of the difficulty encountered when positioning the optical fibre in the presence of adhesive.

### SUMMARY OF THE INVENTION

The purpose of this invention is to propose a structure for optical coupling between a single-mode optical fibre and a single-mode planar nanophotonic waveguide of the aforementioned type, which allows positioning of the fibre in the air while reducing, or even eliminating, the transmission loss caused by the use of adhesive.

To this end, the object of the invention is a single-mode planar nanophotonic waveguide, comprising an optical core, a cladding coating the optical core, and a structure for the optical coupling of the guide core with the core of a single-mode optical fibre, said coupling structure comprising:
an adaptation element including a gradual broadening of the waveguide core ending in a broadened region of dimension adapted to the core of the optical fibre; and
a light transmission element, optically connected to the broadened region, and defining a plane coupling surface by which the light is transmitted to the optical fibre, the optical coupling ratio through said surface when said surface is in contact with the air being maximum for a predetermined coupling angle of the light relative to the coupling surface

According to the invention, the planar waveguide further comprises a prism including a first and a second plane face, the first face being arranged on or in contact with the coupling surface and the second face being intended to engage optically with the optical fibre, the two faces being angularly separated from one another by an angle whereof the value is substantially equal to an angle of refraction in the prism at the coupling surface.

Put another way, the prism defines a new coupling surface for the transmission of light between the waveguide and the optical fibre having the characteristic according to which the coupling angle is now zero, i.e. for a normal light at this surface. In fact, if the coupling angle in the air is zero, it is also zero for any other material, and particularly adhesive. Since the coupling angle is now invariant, it is therefore possible to implement the positioning in the air and then to add adhesive without the corresponding refractive index variation inducing an angle variation and therefore a transmission loss.

It will be noted in this respect that the overall structure of the prior art waveguide is not modified and that the inventive prism may be considered as an optical element for the angular correction of the conventional coupling structure. In particular, the inventive prism involves no modification of the prior art transmission element, such as for example a periodic slit-grating.

Additionally, there is generally an imprecision about the value of the coupling angle associated with the surface of the transmission element due, for example, to fabrication tolerances. However, even if the inventive prism does not exactly compensate for the coupling angle of the transmission element, it does nonetheless allow the angular variation caused by differences in refractive indices between the air and the adhesive to be minimized, as will be explained in further detail below.

According to one inventive embodiment, the transmission element includes a periodic slit-grating formed on one face of the broadened region, the prism being arranged on the cladding flush with the periodic slit-grating.

According to one embodiment, the second face of the prism inscribes an end section of the optical fibre with which the second face of the prism is intended to engage optically.

According to one inventive embodiment, the prism and a portion of the cladding on which the prism is arranged have substantially the same refractive index value, and are in particular constituted by a single material. In particular, the prism and said portion are made of silica.

A further object of the invention is a system for optical coupling between a nanophotonic circuit and a single-mode optical fibre, the optical fibre comprising a core ending in a plane face normal to the direction of propagation of the light in the fibre, which according to the invention, comprises:
a planar nanophotonic waveguide of the aforementioned type; and
means for holding the optical fibre in such a way that the plane end face of the core of the optical fibre is opposite, and parallel, to the second face of the prism of the planar waveguide.

According to one embodiment, the holding means include adhesive arranged between the plane section of the fibre core and the second face of the prism.

According to one embodiment, the prism, a portion of the cladding on which the prism is arranged, and the adhesive have substantially the same refractive index value. In particular, the prism and said portion are made of silica, and the adhesive is constituted by a polymer of the epoxide type.

A further object of the invention is the use of a prism in a planar nanophotonic waveguide of the prior art to form a plane surface determining a coupling ratio in air through said surface that is maximum for a light that is normal at said surface.

### BRIEF DESCRIPTION OF THE DRAWINGS

The invention will be better understood from reading the following description, provided solely by way of example, and given in relation to the appended drawings, wherein identical references denote identical elements, and wherein:

FIGS. 1 and 2 are a cross-section view and a detailed view from above respectively of a nanophotonic waveguide including a prior art optical coupling structure, as already described in the preamble;

FIGS. 3A and 3B are perspective views of two alternative embodiments of a planar nanophotonic waveguide, as already described in the preamble;

FIG. 4 is a decibel curve of the coupling ratio of the coupling structure as a function of the angular deviation of an optical fibre relative to the coupling angle of the coupling structure;

FIG. 5 is a plotting of the coupling angle of the structure in FIGS. 1 and 2, in the air and in an adhesive, as already described in the preamble;

FIG. 6 is a cross-section view of a coupling structure according to the invention;

FIG. 7 is a more detailed cross-section view of a slit-grating of the coupling structure;

FIG. 8 is a plotting of the coupling angle difference between air and adhesive, with or without the inventive prism;

FIGS. 9 and 10 are simplified perspective views respectively of a prism common to a plurality of planar waveguides and of a plurality of prisms each associated with one waveguide of a plurality of waveguides; and

FIG. 11 is a broadened view of the coupling structure showing the angles of refraction in the general situation where the refractive indices of the waveguide and of the prism are different.

### DETAILED DESCRIPTION OF THE INVENTION

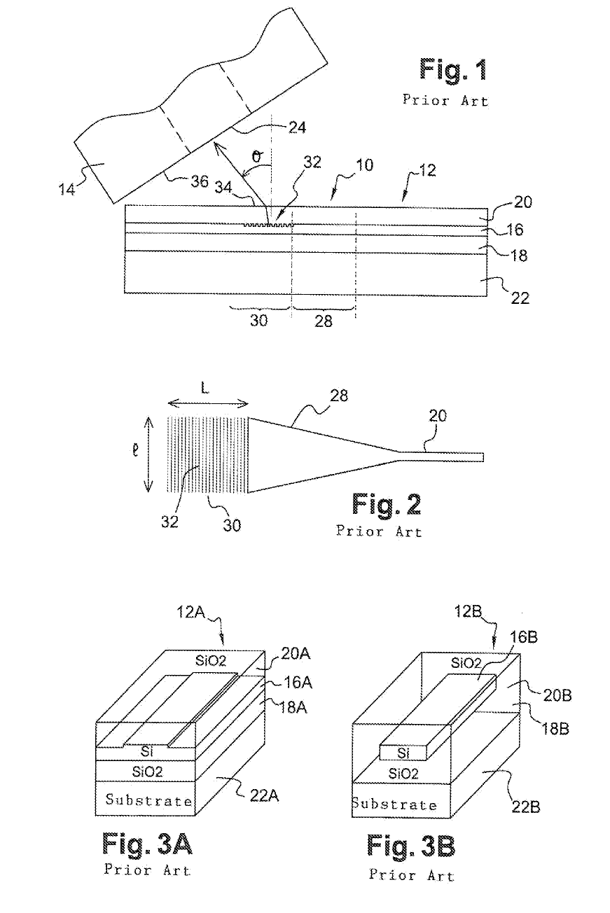

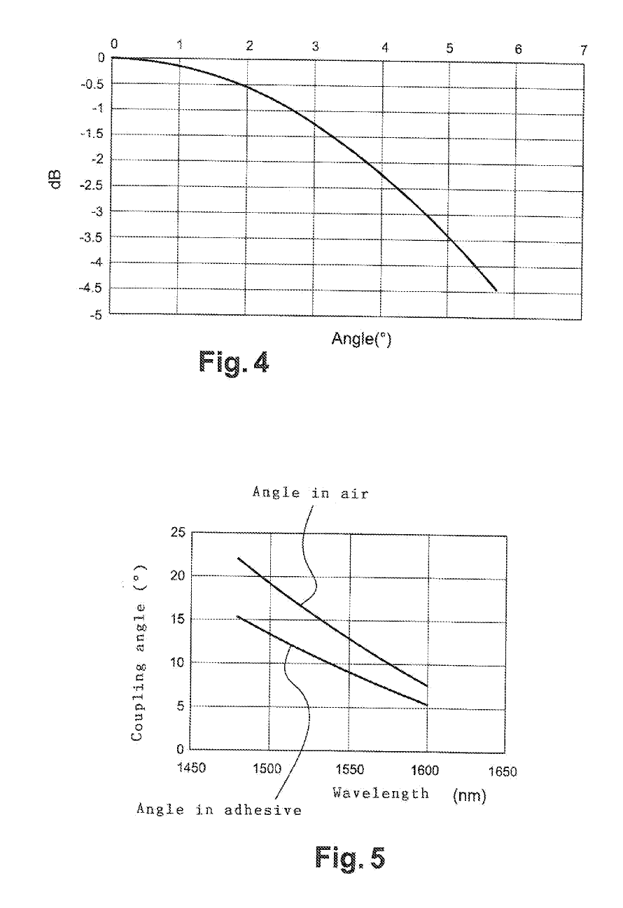

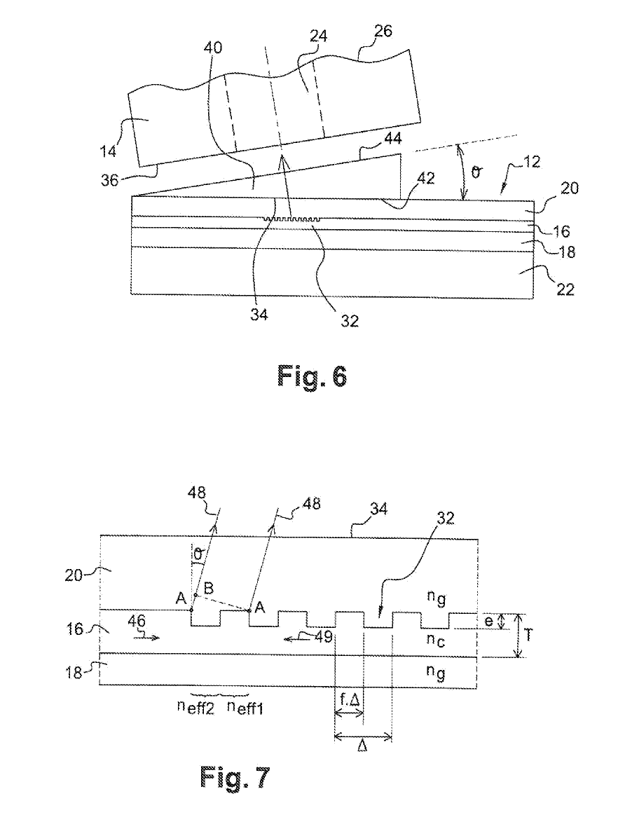

An inventive embodiment is described in relation to FIG. 6 that implements the prior art optical coupling structure, for example the one described in relation to FIGS. 1 to 3, completed by a wedge-shaped prism 40, having a first rectangular plane face 42 secured to the upper cladding 20 and covering at least the coupling surface 34, and a second rectangular plane face 44 forming with the first plane face 42 an angle equal to the coupling angle θ in the air of the coupling surface 34. The refractive index np of the prism 40 is furthermore equal to the refractive index ng of the upper cladding 20 for a selected wavelength, and to advantage for the central wavelength of a spectrum for transmission between the optical coupling structure 10 and the optical fibre 14, this spectrum being defined in particular for the application under consideration of the structure 10 and the fibre 14. The prism 40 and the upper cladding 20 are made for example out of the same material.

The second face 44 of the prism 42 thus defines a new coupling surface for which the coupling angle is zero. The optical coupling ratio is thus maximum for a light that is normal at the plane of the face 44, whatever the material is between the optical fibre 14 and the face 44 of the prism 40. By placing the section 36 of the optical fibre 14 parallel to the face 44 and above the slit-grating 32, the transmission between the optical fibre 14 and the waveguide 12 is then guaranteed to be optimum both in the air and in the adhesive. The fibre can thus be positioned in the air without the subsequent addition of adhesive impacting on the coupling ratio.

The coupling angle in the air of the surface 34 may be easily calculated numerically using FDTD (finite-difference time-domain) numerical modelling or even analytically, as is described for example in the article by C. Kopp, A. Chelnokov, “Fiber grating couplers for silicon nanophotonic circuits: Design modeling methodology and fabrication tolerances”, Optics Communications, Volume 282, Issue 21, 4242-4248 (2009).

With reference to FIG. 7, which is a more detailed view of the slit grating 32, for a light beam to emerge from the diffraction grating 32 at an angle θp (propagative coupling, beam 46 towards beam 48) or at an angle θc (counter-propagative coupling, beam 49 towards beam 48), the phase agreement condition between points A and B has to be satisfied. Thus, the phases φA and φB, at points A and B respectively, must satisfy the condition:

φA−B=2π.mp in the propagative case,

et φA−φB=2π.mc in the counter-propagative case,

mp and mc being whole numbers.

The phase shift between points A and B is equal to, in the case of propagative coupling (beam 46 towards 48):

$${ϕ}_{A} - {ϕ}_{B} = 2 π {m}_{p} = \frac{2 π}{λ} \cdot {n}_{g} \cdot Δ sin {θ}_{p} - \frac{2 π}{λ} [ f \cdot Δ {n}_{eff 1} + ( 1 - f ) \cdot Δ {n}_{eff 2} ]$$

and, in the case of counter-propagative coupling (beam 49 towards 48):

$${ϕ}_{A} - {ϕ}_{B} = 2 \cdot π \cdot {m}_{c} = - \frac{2 π}{λ} \cdot {n}_{g} \cdot Δ sin {θ}_{c} - \frac{2 π}{λ} [ f \cdot Δ {n}_{eff 1} + ( 1 - f ) \cdot Δ {n}_{eff 2} ]$$

λ being the wavelength of the light beam under consideration, and neff1 and neff2 the actual indices of the guide portions of different thicknesses over one period of the grating 32.
This is then equivalent to the following system:

$${n}_{g} \cdot sin {θ}_{p} - f \cdot {n}_{eff 1} + ( f - 1 ) \cdot {n}_{eff 2} = \frac{{m}_{p} λ}{Δ} \\ - {n}_{g} \cdot sin {θ}_{c} - f \cdot {n}_{eff 1} + ( f - 1 ) \cdot {n}_{eff 2} = \frac{{m}_{c} λ}{Δ}$$

With all parameters being known, it is thus possible to calculate as a function thereof the angle θp or the angle θc according to the direction of propagation of the light in the waveguide 12 (mp and mc being fixed; if the diffraction order +1 is considered, then m=1). Since furthermore the refractive indices of the upper cladding 20 and of the air are known, the coupling angle θ at the surface 34 of the cladding 20 is then straightforwardly deduced therefrom.

Clearly, when the coupling angle of the surface 34 is calculated as a function of a mathematical modelling which uses precise values for the dimensions and the indices of the different elements of the waveguide 12 and of its optical coupling structure 10, the value so calculated may be different from the real value of the coupling angle for a particular waveguide. Indeed, even if the methods of fabrication of the waveguide elements and its coupling structure aim for said precise values, they are nonetheless of limited precision. Likewise, the method of fabrication of the prism 40 may also be of limited precision.

Due to a lack of precision in fabrication, the prism 40 may not compensate perfectly for the real coupling angle of the coupling surface 34. In fact, the problem related to the difference that exists between the coupling angle in the air and the coupling angle in the adhesive may subsist.

However, even if the prism 40 is fabricated at an angle between the faces 42 and 44 different from the real coupling angle of the coupling structure 10 with which it is combined, the effect of the prism 40 is to advantage to reduce the losses caused by the difference between the coupling angle in the air and the coupling angle in the adhesive.

Indeed, returning to the example of a coupling set to the 1550 nanometre wavelength, implementing:
an upper cladding 20 of silica with a refractive index n=1.44 and a thickness of 700 nanometres,
a ribbon waveguide core 12 of silicon with a refractive index equal to 3.47 and a thickness of 220 nanometres
said waveguide extending, via the “taper” 28, by a broadened region 30 wherein a grating 32 10 micrometres in width and length is engraved, the periodicity and the depth of the slits being 630 nanometres and 70 nanometres respectively,
and a lower cladding 18 of silica with a refractive index equal to 1.44 and a thickness of 2 micrometres;
   the coupling angle in the air of the surface 34 is equal to 10°. With an adhesive of refractive index equal to 1.45, the coupling angle in the adhesive of the surface 34 is then equal to 6°.

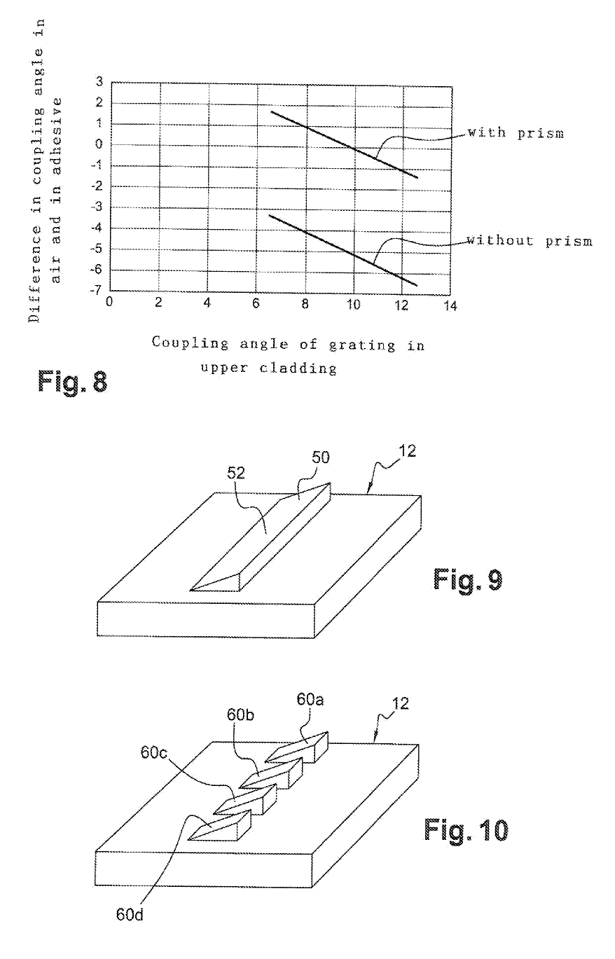

With reference to FIG. 8, and assuming that the fabrication tolerances of the elements described above lead to a real coupling angle in the air of between 10° and 19°, the real coupling angle in the adhesive is then between 7° and 13°. There is therefore a maximum difference between the two angles in excess of 6°, which then corresponds in the absence of a prism to a possible trimming of the coupling ratio in excess of 5 dB (see FIG. 5).

By adding an inventive prism, whereof said first and second faces form between them an angle of 10°, the variation in the coupling angle in the air defined relative to the second face 42 of the prism is no more than from 5.5° to 14.5°. The angular variation, moving from air to adhesive, is thus at worst of 1.5°, which represents a trimming of the coupling ratio of less than 0.3 dB, as may be easily calculated from the refraction formula at the interface between two media of different refractive index.

Thus, even if the prism is not actually optimised for the real coupling angle of the surface 34, there does nonetheless ensue from using it a substantial reduction in the losses related to the introduction of the adhesive.

To advantage, the materials constituting the prism 40, the upper cladding 20 and the adhesive are selected to afford the best possible continuity of the refractive index in order to avoid any index deviation that might generate transmission losses by Fresnel reflection at the interfaces. Thus, the refractive indices of the upper cladding 20, the prism 40 and the adhesive are selected to be as close as possible, and preferably identical, for a wavelength, and for example a central wavelength, of the spectrum for transmission between the optical coupling structure 10 and the optical fibre 14. The optical transmission is in this case maximum since there is no loss by reflection at the interfaces and the optical path is rectilinear since there is no refraction effect at the interfaces.

Thus, a preferred material for the upper cladding 20 and the prism 40 is silica with a refractive index equal to 1.44, and the adhesive is constituted by an epoxide polymer with a refractive index equal to 1.45. Clearly, other materials may be selected as a function of the fabrication method used, particularly to fabricate the prism 40.

To advantage also, the dimensions of the prism 40 are selected in such a way that the section 36 of the optical fibre 14 is inscribed in the second face 44. For example, for a cladding 26 of the optical fibre 14 with an external diameter of 125 micrometres, the length and the width of the second face 44 of the prism 40 are greater than or equal to 125 micrometres. This in particular makes it easier subsequently to bond the optical fibre 14 to the surface 44 of the prism and to reduce the quantity of adhesive required. Preferably however, the dimensions of the prism will be selected to be as small as possible so that the prism does not have too significant a thickness, which may induce a transmission loss. Thus for example, the width and the length of the prism are selected to be substantially equal to 125 micrometres.

As an alternative, the dimensions of the prism 40 are selected in such a way that the first face 42 has dimensions substantially equal to those of the periodic slit grating, or dimensions smaller than those of the grating 32. The parts are thus smaller and therefore easier to fabricate. Additionally, gratings are commonly over-sized, typically 15 μm by 10 μm whereas their actually used surface is 6 μm by 6 μm, so as to be able to see them. Thus a prism of length equal to 125 μm, gives a factor 10, advantageous for fabrication.

An embodiment has been described wherein an optical coupling is implemented between a single optical fibre and a single waveguide. Clearly, as is known from the prior art, a nanophotonic circuit may contain a plurality of planar waveguides each needing to be connected to an optical fibre.

To advantage, as is shown in FIG. 9, the coupling structures 10 of the different single-mode planar nanophotonic waveguides are identical and their periodic slit gratings 32 end on one and the same line 50. A single prism 52 is then made to simplify fabrication.

As an alternative, as shown in FIG. 10, one prism 60a, 60b, 60c, 60d may be used per waveguide, which allows different waveguides to be designed which may have different dimensions.

The prism or prisms are fabricated by micro-replication, for example by hot embossing or by UV cast embossing or UV cast imprint. To advantage, a plurality of prisms of a single face of a nanophotonic circuit are fabricated collectively in a single micro-replication operation.

Micro-replication comprises dispensing a fluid organic compound, and typically an epoxy adhesive or a transparent thermoplastic material in the vitreous state, on the surface of the circuit, in the form of a layer whereof the thickness is close to the intended height of the prism. A structured mould whereof the hollow patterns correspond to the complementary of the patterns to be made, in this case the prism or prisms, is then applied.

Once the mould is applied, the structured layer of organic compound is cross-link hardened by heating or by application of ultra-violet rays. These techniques are described for example in the documents by Becker et al. “Hot embossing as a method for the fabrication of polymer high aspect ratio structures”, J. Sensors and Actuators A: Physical, Volume 83, Issues 1-3, 22 May 2000, Pages 130-135, and by Rudman et al. “Design and fabrication technologies for ultraviolet replicated micro-optics”, Opt. Eng. 43(11), 2004.

The organic compound used for the prisms is to advantage a polymer. For example in the case of hot embossing, an optical adhesive is preferred, and for example epo-tek 353ND fabricated by the company Epoxy Technology, Inc. or a thermoplastic polymer, such as PMMA for example. The optical adhesive allows patterns to be obtained that are particularly stable in temperature, through its high vitreous transition temperature (Tg=120° C.) and its degradation temperature (Tmax=400° C.).

In the case of UV cast embossing, an optical adhesive that will crosslink under UV is preferred, such as for example ChemOptics CO150, fabricated by the company Chemoptics Inc., or epotek OG142 fabricated by the company Epoxy Technology, Inc. These two materials have the advantage of having a relatively fast ultra-violet cross-linking time (of about a minute) relative to polymers with thermal cross-linking, which leads to a shorter prism fabrication cycle.

Embodiments have been described wherein the refractive index np of the prism 40 is equal to the refractive index ng of the upper cladding 20 for a given wavelength of a spectrum for transmission between these two elements, and in a preferred alternative, an identity between the refractive indices of the prism, the upper cladding and the adhesive.

Some applications may however compel the use of different refractive indices for the prism 40 and the upper cladding 20, for example in the situation where the materials constituting same are imposed. To obtain an optimum coupling between the optical structure 10 and the optical fibre 14 in a situation such as this, the angle of the prism 40 is also calculated to compensate for the deviation in refractive indices between the prism 40 and the upper cladding 20 and therefore to compensate for the angular refraction at the interface between the prism 40 and the cladding 20.

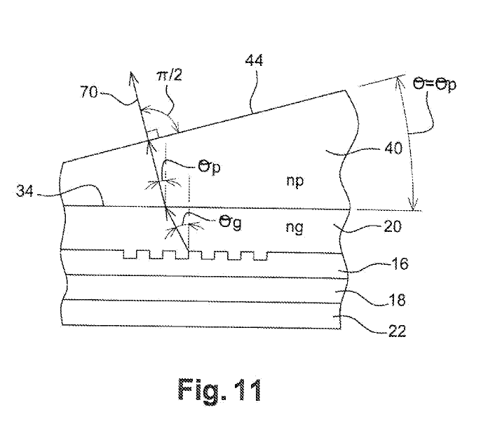

With reference to FIG. 11, which is a broadened view of the coupling structure 10 and of the prism 40, if we denote in a general way:
θ_{g} the coupling angle in the upper cladding 20 relative to the vertical at the plane of the core 16, and ng the refractive index of the upper cladding 20;
θₚ the coupling angle in the prism 40 relative to the vertical at the plane surface 34 of the cladding 20, and np the refractive index of the prism 40; and
θ the angle of the prism 40 with the surface 34
   to obtain a light beam 70 orthogonal to the surface 44 of the prism 40 and therefore a zero coupling angle with the optical fibre 14, the angle θ of the prism 40 is selected to be equal to the angle θₚ, in which case the Fresnel relationship at the interface between the prism 40 and the cladding 20, nₚ×sin(θₚ)=n_{g}×sin(θ_{g}), is verified.

It will be noted that for identical refractive indices for the prism 40 and the upper cladding 20, n_{g}=nₚ, we get θ_{g}=θₚ, and therefore θ=θₚ=θ_{g} of the embodiments described previously.

The table below describes a few numerical examples of refractive indices and angles.

| n_{g} | θ_{g}(°) | nₚ | θₚ(°) | θ |
|---|---|---|---|---|
| 1.45 | 10 | 1.3 | 11.2 | 11.2 |
| 1.45 | 10 | 1.4 | 10.4 | 10.4 |
| 1.45 | 10 | 1.45 | 10.0 | 10.0 |
| 1.45 | 10 | 1.6 | 9.1 | 9.1 |
| 1.45 | 10 | 1.7 | 8.5 | 8.5 |

The following table describes examples of materials for the prism 40 with their respective refractive indices.

| Material | Refractive index | Chemical base | Cross-linking type |
|---|---|---|---|
| ChemOptics | 1.514 | Acrylate | UV |
| CO150 | | | |
| Epotek 353ND | 1.5694 | Epoxy | Thermal |
| Epotek OG142 | 1.5692 | Epoxy | UV |
| PMMA | 1.4914 | Polymethyl- | (thermoplastic) |
| | | methacrylate | |

The indices of the materials described above are those of the marketed products, the composition of the materials being able to be modified in order to obtain different refractive indices. For example, the composition of ChemOptics CO150 may be modified to obtain a refractive index that may reach the value of 1.628.

Embodiments have been described wherein the transmission element used to transmit light into or out of the core 16 of the optical guide 12 is a periodic slit grating 32 providing a diffraction function. Clearly, the invention applies to any type of diffraction element, provided a coupling surface is defined at the surface of the waveguide and which has a non-zero coupling angle.

1. A single-mode planar nanophotonic waveguide, comprising an optical core, a cladding coating the optical core, and a structure for optical coupling of the core of the waveguide with the core of a single-mode optical fibre, said coupling structure comprising:
an adaptation element including a gradual broadening of the core of the waveguide ending in a broadened region of dimension adapted to the core of the optical fibre; and
a light transmission element, optically connected to the broadened region, and defining a plane coupling surface by which light is transmitted to the optical fibre, an optical coupling ratio through said surface when said surface is in contact with air being maximum for a predetermined coupling angle of the light relative to the coupling surface,
wherein the planar waveguide further comprises a prism including a first and a second plane face, the first face being arranged on or in contact with the coupling surface, and the second face being intended to engage optically with the optical fibre, the two faces being separated angularly from one another by an angle substantially equal to an angle of refraction in the prism at the coupling surface.

2. The waveguide as claimed in claim 1, wherein the transmission element includes a periodic grating of slits formed on one face of the broadened region; the prism being arranged on the cladding flush with the periodic slit grating.

3. The waveguide as claimed in claim 1, wherein the second face of the prism inscribes an end section of the optical fibre with which the second face of the prism is intended to engage optically.

4. The waveguide as claimed in claim 1, wherein the prism and a portion of the cladding on which the prism is arranged have substantially the same refractive index value.

5. The waveguide as claimed in claim 4, wherein the prism and said portion of the cladding are made of silica.

6. A system of optical coupling between a nanophotonic circuit and a single-mode optical fibre, the optical fibre comprising a core ending in a plane face normal to a direction of propagation of light in the optical fibre:
wherein said system comprises a planar nanophotonic waveguide in accordance with claim 1; and
wherein said system comprises means for holding the optical fibre in such a way that the end plane face of the core of the optical fibre is opposite, and parallel, to the second face of the prism of the planar waveguide.

7. The coupling system as claimed in claim 6, wherein the holding means include adhesive arranged between the plane section of the fibre core and the second face of the prism.

8. The coupling system as claimed in claim 7, wherein the prism, a portion of the cladding on which the prism is arranged, and the adhesive have substantially the same refractive index value.

9. The coupling system as claimed in claim 8, wherein the prism and said portion of the cladding are made of silica, and the adhesive is constituted by an epoxide polymer.

10. Use of a prism in a planar nanophotonic waveguide comprising an optical core, a cladding coating the optical core, and a structure for optical coupling of the core of the waveguide with the core of a single-mode optical fibre, said coupling structure comprising:
an adaptation element including a gradual broadening of the core of the waveguide ending in a broadened region of dimension adapted to the core of the optical fibre; and
a light transmission element, optically connected to the broadened region, and defining a plane coupling surface by which light is transmitted to the optical fibre, an optical coupling ratio through said surface when said surface is in contact with air being maximum for a predetermined coupling angle of the light relative to the coupling surface,
to form a plane surface determining a coupling ratio in the air through said surface that is maximum for a light that is normal at said surface.

11. The waveguide as claimed in claim 4, wherein the prism and the portion of the cladding on which the prism is arranged are formed of the same material.
